(19) United States
(12) Patent Application Publication
(10) Pub. No.: US 2005/0166059 A1
(43) Pub. Date: Jul. 28, 2005

(54) Customised goods and services delivery method

(76) Inventors: Axel Hausen, Moerfelden (DE); Thierry Mougin, Saint Vit (FR)

Correspondence Address: SOFER & HAROUN LLP., 317 MADISON AVENUE, SUITE 910, NEW YORK, NY, 10017, US

(21) Appl. No.: 10/509,486

(22) PCT Filed: Mar. 13, 2003
(86) PCT No.: PCT/FR03/00812

(30) Foreign Application Priority Data
Mar. 29, 2002 (FR) 02/04481

(51) Int. Cl. H04K 1/00

(52) U.S. Cl. 713/182

(57) ABSTRACT

The invention relates to a method of delivering goods or services to a user, such as a temporary parking authorization for a motor vehicle, by an automatic terminal, such as a ticket machine. The inventive method is characterized in that it comprises the following steps: i) identification of the user by the terminal and ii) after identification, automatic allocation by the terminal of specific goods or services delivery conditions, said conditions being particular to the user.

The present invention relates to a method of delivering by means of an automatic device goods or services that may be adapted as a function of the user. The present invention relates more particularly to paying for a parking space for an automobile or road vehicle by means of an automatic payment terminal, such as a parking voucher dispenser, a parking meter or an automatic payment station; the present invention also relates to automatic devices adapted to implement this kind of method.

The price and quantity of the goods or services delivered by an automatic device such as a parking terminal may vary as a function of the user. Thus the holder of a season ticket for a car park pays a different price to an occasional user and appropriately registered residents benefit from a reduced charge and an unlimited parking time in the streets of their own district, whereas non-resident users are restricted to two hours parking.

Conventionally, to obtain the benefit of these advantages, the user must register with the organization managing the car park and obtain either a sticker to be affixed to the windshield of the vehicle to enable parking wardens to check that the user is entitled to the reduced charges or to a specific parking time or a magnetic stripe card or a smartcard that is read, with or without contact, by the automatic device and in which are stored the rights of the user to access the services and the charges concerned.

The management by the management organization of facilities of the above kind made available to users proves to be relatively costly, in particular with regard to the problems of updates, the complexity of the terminals, etc.

The separate management of a card or a sticker also gives rise to numerous problems concerning the interworking of the system (between roadside terminals and car park terminals, for example), the responsibility for managing rights according to the various issuers of the rights, and the duration of the rights compared to the service life of the medium (e.g. the card).

The object of the present invention is therefore to propose a method of paying at appropriate automatic devices that simplify the management of users.

According to the invention, a method of delivering goods or services to a user, such as a temporary authorization to park an automobile vehicle, by an automatic terminal, such as a parking voucher dispenser, is characterized in that it comprises the following steps:
i) identification of the user by the terminal, and
ii) after identification of the user, automatic assignment by said terminal of particular conditions specific to the user for the delivery of goods or services.

According to another feature of the method of the present invention, the particular conditions relate more particularly to the price of and/or the method of payment for said goods or services.

According to another feature of the method of the present invention, the identification step consists in comparing identification data supplied by said user with identification data stored at least partially in said terminal.

According to another feature of the method of the present invention, the identification data stored in said terminal is regularly downloaded from a remote server connected to said terminal by an appropriate telecommunication network.

According to another feature of the method of the present invention, the identification step consists in comparing identification data supplied by said user to identification data stored in a remote server to which said terminal is connected by an appropriate telecommunication network.

According to another feature of the method of the present invention, the identification data supplied by said user comprises the number of a payment card, said number being read by appropriate reading means of said terminal.

According to another feature of the method of the present invention, the identification data supplied by said user comprises a number communicated to said terminal by said user by means of input means of said terminal.

According to another feature of the method of the present invention, the identification data supplied by said user comprises the telephone number of said user.

According to another feature of the method of the present invention, the identification data comprises a password personal to said user.

The following description with reference to the appended drawings of nonlimiting embodiments of the invention explains in what the invention consists and how it may be put into practice.

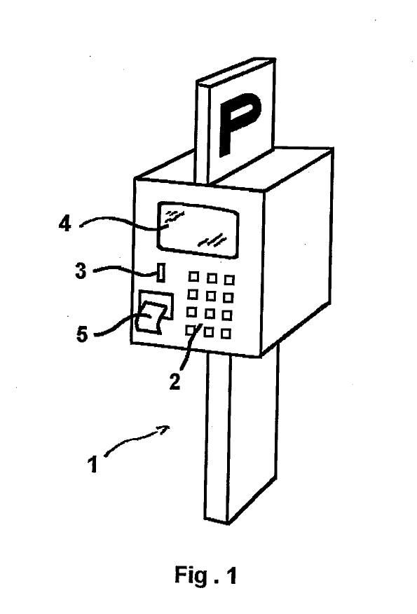

FIG. 1 is a diagrammatic representation of a parking voucher dispenser according to the invention.

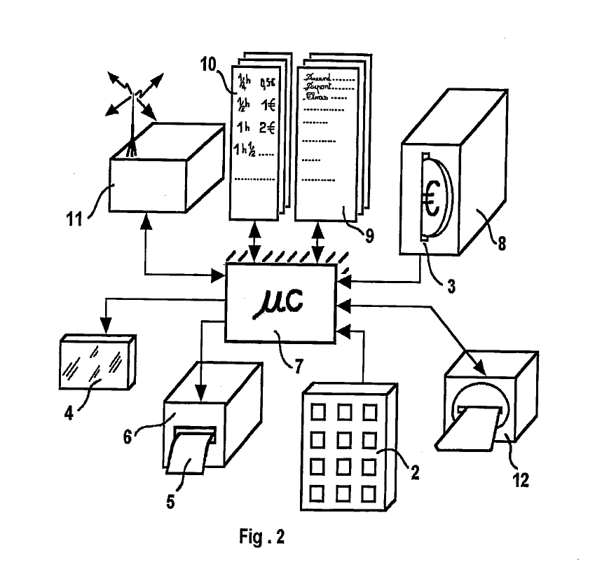

FIG. 2 is a block diagram showing how the invention is put into practice.

FIGS. 1 and 2 show one example of an automatic payment terminal in the form of a parking voucher dispenser 1 intended to control a certain number of roadside parking spaces. Obviously the present invention applies more generally to any type of automatic payment terminal, such as parking meters, access control terminals, automatic drinks dispensers, payment terminals in car parks, transport ticket dispensers, etc.

As is well known in the art, the parking voucher dispenser 1 comprises selection and validation means such as a keypad 2, one or more slots 3 for inserting coins or a reader 12 for reading a payment card, bank card or electronic purse, and a data display screen 4. Coins inserted into the slot 3 are processed by a coin sorter 8 that detects the amount inserted into the slot 3. In a similar way payment cards of the microprocessor or memory type are processed by appropriate card reading means. The parking voucher dispenser further comprises printing means 6, for example a thermal printer, adapted to deliver a parking authorization in the form of a voucher 5.

If the motorist wishes to leave his vehicle parked in one of the spaces controlled by the parking voucher dispenser 1, he must go to the parking voucher dispenser, where applicable choose his tariff (resident, season ticket holder, etc.), and pay a certain sum of money for a parking time or a required amount, by means of coins, a payment card, banknotes or any other means of payment accepted by the terminal 1, or a combination of the above payment means.

The parking authorization having been paid for, the motorist is then authorized to park for a certain time. The parking voucher dispenser delivers a voucher 5 on which is printed information including the end of the authorized parking time. The motorist must place this voucher behind the windshield of the vehicle to prove that he has paid to park.

A parking warden therefore has only to compare the time on the voucher with the current time to determine if the vehicle is legitimately parked or not, and in the latter case to issue a parking ticket to the motorist.

This type of parking management system has the advantage for the user of being very clear, since the time at which the authorization to park expires is shown clearly on the voucher that he has received, and the benefit for the authorities that use these systems of a relatively low investment and easy control. The voucher may also serve as a receipt for the payment made by the user.

The operation of the parking voucher dispenser 1 will now be described more particularly with reference to FIG. 2. The parking voucher dispenser comprises an electronic circuit including a computer (microcontroller) 7 controlling the operation of the various units of the parking voucher dispenser 1. Using an appropriate clock circuit, the computer 7 calculates the time at which the authorization to park expires from tariff information (where applicable entered by the user), the amount paid, and stored tariff tables 10. This time is displayed on the display panel 4. When the user has accepted this time, by pressing an appropriate button on the keypad 2, the computer 7 takes in the money and commands the printing means 6 to print out an appropriate voucher 5.

The tariff tables 10 and the programs executed by the computer 7 may be updated, preferably from a remote central server, not shown, to which the computer 7 has access via transceiver means 11 and a cable communication network, such as the public switched telephone network (PSTN), a radio network, such as a GSM (SMS), Mobitex, GPRS, or UMTS network, or an IR, Bluetooth, etc. link. However, updating may also be performed manually: an operative then regularly updates the data in each of the payment terminals 10 from a diskette, a CD-ROM, a portable computer, by physically changing the data memory (PCMCIA, Compact Flash, Eprom, etc. card) or by direct entry at the terminal, which in this case is provided with an appropriate input interface.

According to the invention, the terminal 1 is also adapted to process individualized parking entitlements providing payment conditions and tariffs tailored to particular users, which may be stored in the terminal 1 itself or accessed via a remote server to which the terminal 1 is connected.

These individual parking entitlements relate to access at specific reduced charges, such as a residents' charge, or even to access that is free of charge, as well as to specific functions, such as real time parking, extension of the maximum parking time, a loyalty program, with bonus points to be stored, the ease of reserving a parking place, the display of a personalized welcome message, etc. These individual parking entitlements also relate to payment conditions, such as prepayment, post-payment, credit payment, minimum or maximum ceilings, conditions for recharging the means of payment, etc.

Thus users wishing to benefit from particular tariffs, for example a residents' tariff, and/or customized payment arrangements (monthly, etc.) are invited to register with the operator in charge of parking, i.e. the manager of the installed base of parking voucher dispensers.

To subscribe, the user provides personal identification information, for example his name, home address (if required for access to residential parking), his occupation, etc., and chooses formulas that will determine his parking rights, for example tariff parameters that will be specific to him such as access at a preferential tariff (lower price, fixed charge, free of charge, payment/refunding of a deposit, etc.).

The user also determines the financial conditions for access to the service. These payment parameters relate to the financial capabilities assigned to the user in terms of payment time and amount; like bank cards or credit cards, it may be a question of applying a ceiling to the amount expended by the user in a given time period or a given transaction, etc. The user also determines the required payment method, as described in detail hereinafter.

Similarly, the user may be prompted to choose from various optional services offered by the operator, for which there may be a charge, such as automatic callback to the user to advise him of the end of his paid parking time, etc.

Similarly, the user may be prompted to choose from various services relating to the payment for services to be billed to him: recharging of his account, authorized credit, prepayment, etc.

Similarly, the user may subscribe to other services offered by parking voucher dispensers, which may be interactive terminals offering access to a certain number of services: city guide, hotel reservations, taxi service, etc.

Of course, the above parking rights are delivered subject to certain conditions: time limits (duration or specific time), geographical limits (one terminal, one group of terminals, the whole installed base of parking voucher dispensers, etc.) and monetary limits (minimum/maximum amount).

On registering, the user also determines an identification data item forming an access key by means of which he is recognized by the terminal 1 and allowed to exercise his parking rights. This data item may be a number issued by the car park operator and stored on an appropriate card that the terminal 1 is able to read. The identification data item may equally take the form of the number of the user's bank card or mobile telephone or the number of the subscriber identity module (SIM) card in his mobile telephone. The identification data item may equally take the form of the registration number of his vehicle or the number of a reserved parking space. More generally, any information medium uniquely identifying the user, such as a loyalty card, that may be read by appropriate reading means of the terminal 1 may be used.

The identification data item may be associated with a secret code or a personal identification number (PIN) code, such as a four-digit number, for authenticating the user and making access to the terminal 1 more secure.

All of the above personal information, parking rights, payment rights, identification data and associated secret codes concerning users, is stored in appropriate memory areas 9 of the parking voucher dispenser 1 using data transfer means described hereinabove with reference to the tariff tables and programs of the computer 7.

When the user goes to the parking voucher dispenser 1, it suffices for him to identify himself, for example by inserting his bank card (or his parking card, etc.) and to authenticate himself by entering his PIN code. The computer 7 then verifies the data entered against the stored data and, if the user is in the list stored in the area 9, uses the corresponding tariff and payment data to determine the parking charge in particular. Obviously, only residents of the district in which the parking voucher dispenser 1 is located are stored therein.

Accordingly, thanks to the invention, only a resident properly registered in the parking voucher dispenser 1 is able to benefit from a residents' tariff. There is therefore no longer any requirement to issue this kind of user with a particular card or to affix a corresponding sticker to the windshield of his vehicle. The verification and management of users of this kind are therefore simplified.

To prevent fraud, the computer 7 may carry out checks, for example to prevent a user who is a resident obtaining more than one ticket at the residents' tariff for a given time period.

Obviously, the embodiments shown are provided by way of example only and are in no way limiting on the set of solutions that may be implemented thanks to the present invention.

Thus the user data may be stored only in a remote centralized server that the parking voucher dispenser 1 accesses on line if a user wishes to benefit from a particular tariff.

1. Method of delivering goods or services to a user, such as a temporary authorization to park an automobile vehicle, by an automatic terminal, such as a parking voucher dispenser, said method comprising the steps of:
i) identification of the user by the terminal, and
ii) after identification of the user, automatic assignment by said terminal of particular conditions specific to the user for the delivery of goods or services.

2. Method according to claim 1, wherein said particular conditions relate more particularly to the price of or the method of payment for said goods or services.

3. Method according to claim 1, wherein said identification step includes comparing identification data supplied by said user with identification data stored at least partially in said terminal.

4. Method according to claim 3, wherein the identification data stored in said terminal is regularly downloaded from a remote server connected to said terminal by an appropriate telecommunication network.

5. Method according to claim 1, wherein said identification step includes comparing identification data supplied by said user to identification data stored in a remote server to which said terminal is connected by an appropriate telecommunication network.

6. Method according to claim 3, wherein said identification data supplied by said user includes the number of a payment card, said number being read by appropriate reading means of said terminal.

7. Method according to claim 3, wherein said identification data supplied by said user further comprises a number communicated to said terminal by said user by means of input means of said terminal.

8. Method according to claim 3, wherein said identification data supplied by said user further comprises the telephone number of said user.

9. Method according to claim 3, wherein said identification data supplied by said user further comprises the number of an information medium uniquely identifying the user, such as a loyalty card, said number being read by appropriate reading means of said terminal.

10. Method according to claim 3, wherein said identification data further comprises a password personal to said user.
